(19) United States
(12) Patent Application Publication
(10) Pub. No.: US 2026/0002078 A1
(43) Pub. Date: Jan. 1, 2026

(54) Fire-Resistant Composition of Matter

(71) Applicant: Nanotech Inc., Spring, TX (US)

(72) Inventors: Claudinei Calado Rezende, Spring, TX (US); Hani Taan, Spring, TX (US)

(73) Assignee: Nanotech Inc., Spring, TX (US)

(21) Appl. No.: 18/624,322

(22) Filed: Apr. 2, 2024

(51) Int. Cl. C09K 21/14

(52) U.S. Cl. CPC C09K 21/14

(57) ABSTRACT

A fire-resistant, cellulose-based composition of matter is provided that can be used in a variety of applications that benefit from added fire resistance. In at least one aspect, the composition of matter includes, by mass: 10 to 70% cellulose; 1 to 15% insulating compound; and 5 to 30% insulative particles. The composition of matter may further include one or more of, by mass: 1 to 15% phosphate additive, 5 to 30% phosphate filler, 3 to 30% water-based binder, or 1 to 20% silica. The insulating compound of the composition of matter may include, by mass: 2 to 60% insulative particles, 5 to 40% silica, and 15 to 50% amorphous silica. Other aspects are described herein.

### TECHNICAL FIELD

The present application relates generally to compositions of matter. More specifically, the present application relates to fire-resistant compositions of matter.

### BACKGROUND

Certain materials are designed to withstand exposure to high temperatures and flames while providing a protective barrier against combustion. Such materials are often used in construction, textiles, and various industries to enhance safety and reduce the risk of fire-related damage. Typical materials with these characteristics can endure elevated temperatures without undergoing significant structure changes and often possess thermally insulative properties. There remains room, however, to improve upon the properties provided by typical materials having these characteristics.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

A new and innovative fire-resistant, cellulose-based composition of matter is provided that can be used in a variety of applications that benefit from added fire resistance. Cellulose on its own is a combustible material. The inventors determined that the combustibility of the cellulose is significantly decreased with the addition of an insulating compound and insulative particles, and embodiments disclosed herein include compositions of matter that combine these materials to provide materials useful for fire-resistant applications. The inclusion of cellulose results in the composition of matter having a lower density than typical fire-resistant materials. Stated differently, the composition of matter can be considered lightweight compared to typical fire-resistant materials. In this way, the composition of matter can add less weight to structures with which the composition of matter is used than typical fire-resistant materials while still providing equivalent or better fire-resistant properties. Cellulose is also recyclable and biodegradable which can provide environmental benefits.

In an example, a composition of matter includes, by mass: 10 to 70% cellulose; 1 to 15% insulating compound; and 5 to 30% insulative particles. The composition of matter is fire-resistant, and the insulating compound includes, by mass: 2 to 60% insulative particles, 5 to 40% silica, and 15 to 50% amorphous silica.

In another example, a method includes positioning a composition of matter relative to a structure thereby providing fire-resistance to the structure. The composition of matter includes, by mass: 10 to 70% cellulose; 1 to 15% insulating compound; and 5 to 30% insulative particles. The composition of matter is fire-resistant, and the insulating compound includes, by mass: 2 to 60% insulative particles, 5 to 40% silica, and 15 to 50% amorphous silica.

In another example, a composition of matter includes, by mass: 10 to 70% cellulose; 1 to 15% insulating compound; and 5 to 30% insulative particles. The composition of matter is fire-resistant, and the insulating compound includes, by mass: 15 to 40% hydrated silicate, and 40 to 80% insulative particles.

The terms “a” and “an” are defined as one or more unless this disclosure explicitly requires otherwise. Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Furthermore, all numerical ranges herein should be understood to include all integers, whole or fractions, within the range, inclusive of the ends of the ranges. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

The terms “comprise” and any form thereof such as “comprises” and “comprising,” “have” and any form thereof such as “has” and “having,” and “include” and any form thereof such as “includes” and “including” are open-ended linking verbs. As a result, an apparatus or system that “comprises,” “has,” or “includes” one or more elements possesses those one or more elements but is not limited to possessing only those elements. Likewise, a method that “comprises,” “has,” or “includes” one or more steps possesses those one or more steps but is not limited to possessing only those one or more steps.

Any embodiment of any of the compositions of matter and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above in order to change the scope of a given claim from what it would otherwise be using the open-ended linking verb.

The feature or features of one embodiment may be applied to other aspects, even though not described or illustrated, unless expressly prohibited by this disclosure or the nature of the aspects.

Some details associated with the aspects are described above and others are described below.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

A further understanding of the nature and advantages of the present disclosure may be realized by reference to the following drawings. In the appended figures, similar components or features may have the same reference label. If just the first reference label is used in the specification, the description is applicable to any one of the similar components having the same first reference label irrespective of the second reference label. Like reference numbers and designations in the various drawings indicate like elements.

FIG. 1 is a graph showing the heating and cooling of an insulating compound coating over time when subjected to direct heat.

FIG. 2 is a graph showing the thermal efficiency of an insulating compound over time.

FIG. 3 illustrates an example box with fire-resistant inserts, according to an aspect of the present disclosure.

FIG. 4 illustrates a prior art insulation board.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case.

A fire-resistant, cellulose-based composition of matter is provided that can be used in a variety of applications that benefit from added fire resistance. Cellulose on its own is a combustible material. The inventors determined that the combustibility of the cellulose is significantly decreased with the addition of an insulating compound and insulative particles, and embodiments disclosed herein include compositions of matter that combine these materials to provide materials useful for fire-resistant applications. One or more additional elements may be added to provide various properties to the composition of matter in various aspects, as will be described below.

Embodiments of the composition of matter may provide one or more of the following advantages. The inclusion of cellulose results in the composition of matter having a lower density than typical fire-resistant materials. Stated differently, the composition of matter can be considered lightweight compared to typical fire-resistant materials. In this way, the composition of matter can add less weight to structures with which the composition of matter is used than typical fire-resistant materials while still providing equivalent or better fire-resistant properties. Cellulose is also recyclable and biodegradable which can provide environmental benefits. The composition of matter may include recycled cellulose in some embodiments. The composition of matter is water-based, which may lead to low volatile organic compound generation during the production process of the composition of matter. The composition of matter is versatile in that the composition of matter can be molded or cast into different geometric shapes or can be applied in the form of a spray to form a coating. For example, in the context of a shipping container (e.g., box), thin panels of the composition of matter can be shaped to the interior of the shipping container, which can increase available shipping space. When burned, the composition of matter may have a low smoke density.

As used herein, “fire-resistant” means having the ability or tendency to slow or halt the spread of fire and to prevent the transit of heat or the increase of temperature on the side away from the fire, up to a threshold temperature or duration of heat exposure. For example, a fire-resistant panel with a first side adjacent to fire slows or halts the spread of the fire and prevents heat from transferring to a second side of the panel opposite the first side such that the temperature of the second side does not increase. And the fire-resistant panel has these properties until it is exposed to a threshold temperature or a temperature for a threshold duration.

### Insulating Compound

In the aspects described below, the composition of matter may include an insulating compound. The insulating compound works efficiently in the transfer of heat by each of conduction, convection, and radiation. Combining improvements in one or more of these three heat transfer attributes results in a more efficient thermally insulative material in some disclosed aspects. Additional features in certain aspects involving the insulating compound include flame retardance, thermal insulation, and anti-corrosion properties.

In various aspects, the insulating compound, prior to being cured, includes at least insulative particles (e.g., 2% to 60% or 10 to 30%), silica (e.g., 5% to 40% or 5 to 10%), and amorphous silica (e.g., 15% to 50% or 25 to 50%). The insulative particles may be nanoparticles. In some aspects (e.g., the tenth example below), as an alternative to including silica, the insulating compound, prior to being cured, includes at least insulative particles (e.g., 40 to 80%), hydrated silicate (e.g., 20 to 40%), and water (5 to 17%). In some aspects, the insulating compound, prior to being cured, further includes suitable combinations of one or more of: electro-fused silica (e.g., 5 to 50%), fibers (e.g., 5 to 40%), bentonite (e.g., 1 to 5%), semiconductors (e.g., 2 to 30%), inert pigments (e.g., 1 to 10%), carbides (e.g., 5 to 35%), additives (e.g., 3 to 20%), resin (e.g., 5 to 60%), and water (e.g., 20 to 60% or 20 to 40%). In some examples, the insulating compound, prior to being cured, includes 10 to 30% insulative particles, 5% to 10% silica, 25% to 50% amorphous silica, and 20 to 40% water. In such examples, the insulting compound, prior to being cured, may further include up to 10% fibers. Each of the example percentages provided throughout this disclosure is by mass unless stated otherwise.

In various aspects, the insulating compound, when cured, includes at least insulative particles (e.g., 4% to 70% or 15 to 45%), silica (e.g., 7% to 60% or 10 to 20%), and amorphous silica (e.g., 17% to 60% or 30 to 50%). In some aspects (e.g., the tenth example below), as an alternative to including silica, the insulating compound, when cured, includes at least insulative particles (e.g., 20 to 70%) and hydrated silicate (e.g., 10 to 50%). In some aspects, the insulating compound, when cured, further includes suitable combinations of one or more of: electro-fused silica (e.g., 5 to 30%), fibers (e.g., 2 to 30%), bentonite (e.g., 1 to 7%), semiconductors (e.g., 2 to 45%), inert pigments (e.g., 1 to 15%), carbides (e.g., 5 to 50%), additives (e.g., 3 to 15%) and resin (e.g., 2 to 70%). In some examples, the insulating compound, when cured, includes 5 to 45% insulative particles, 5% to 20% silica and 10% to 55% amorphous silica. In such examples, the insulting compound may further include up to 30% fibers.

In some aspects, the silica is in the form of particles (e.g., spheres). In such aspects, at least some of the silica particles may have a transverse dimension (e.g., diameter) within a range of 1 to 100 micrometers (μm), inclusive. For example, in some aspects, at least half of the particles of the silica have a transverse dimension within the range of 1 to 100 μm, inclusive. In such aspects, the particles of the silica that are outside the range have a transverse dimension within a range of greater than 100 μm and less than or equal to 1000 μm. In some aspects, all of the particles of the silica have a transverse dimension within the range of 1 to 100 μm, inclusive.

In aspects that include hydrated silicate, the hydrated silicate may be thermally treated with aluminum and magnesium to form a fibrous aluminum silicate. The fibrous aluminum silicate doesn't propagate flame spread and has a low thermal and electrical conductivity with a low density.

As used herein, insulative particles are defined as inorganic, thermally treated reagent particles that demonstrate insulative properties. In various aspects, the insulative particles can react chemically with silica and amorphous silica to form a new phase denominated insulative compound. In some aspects, the insulative particles can react chemically with hydrated silicate to form a new phase denominated insulative compound. In at least some aspects, the insulative particles may be nanoparticles. For example, an insulative nanoparticle may have a transverse dimension (e.g., diameter) within a range of 1 to 100 nanometers (nm), inclusive. In some aspects, at least half of the particles of the insulative nanoparticles have a transverse dimension within the range of 1 to 100 nm, inclusive. In such aspects, the particles of the insulative nanoparticles that are outside the range have a transverse dimension within a range of greater than 100 nm and less than or equal to 1000 nm. In some aspects, all of the particles of the insulative nanoparticles have a transverse dimension within the range of 1 to 100 nm, inclusive. In some aspects, at least some of (e.g., all) the particles of the insulative nanoparticles have a transverse dimension within a range of 10 to 12 nm, inclusive.

Including insulative nanoparticles in the insulating compound may provide the insulating compound with a porosity ranging from nano to mesopore when cured. For example, the insulating compound when cured may include pores having diameters within a range of 1 and 100 nm, inclusive) This pore size distribution enables the insulating compound to reflect a range of wavelengths of radiation, such as ultraviolet to infrared length radiation. The wide range of reflectivity lowers the temperature of the composition of matter including the insulating compound under extreme heat conditions. The nanoparticles have a high surface area with a low thermal conductivity, and form stable dispersions in aqueous solutions. The nanoparticles may be highly reactive based on the large surface area per mass of the nanoparticles. The nanoparticles may be inorganic material that have high heat resistance, good mechanical resistance, and low electrical and thermal conductivity.

Including a semiconductor (e.g., an inorganic semiconductor) in the insulating compound can increase reflectivity of the insulating compound's surface, reducing the surface temperature of the insulating compound when exposed to high temperatures. Example semiconductors include titanium oxide, magnesium oxide, zinc oxide, chromite, nickel-antimony-titanium (Ni—Sb—Ti), and carbides.

Dispersions of silica and/or amorphous silica in the insulating compound can provide strength, hardness, and resistance to high temperatures and thermal shock. Electro-fused silica and/or bentonite may be used as thickeners and binders for the insulating compound.

Fibers of fibrous materials augment the mechanical properties of the insulating compound, such as providing the insulating compound with resistance to traction and flexion. In an example, the fibers contribute to the composition of matter being able to withstand a blast component (e.g., initial explosion, then fire) of a lithium ion battery thermal runaway.

The inert pigments and/or additives are example rheological property modifiers. Example inert pigments include ferric oxides (e.g., greens, reds, yellows, carbon oxide, chromate 3 or 6 (different colors), calcium carbonate (white), etc.).

In some aspects, a resin (e.g., polymeric resin) may be used with the insulating compound as an agent of plasticity, tackiness and binder. In some aspects, the resin may be water-based. In other aspects, the resin is not water-based. Example resins include acrylic, alchemical, epoxy, polyurethane resins, phenol-formaldehyde, polyurethane, furfural resin, poly acrylonitrile, polyimide, sucrose and tannin.

In an example, the insulating compound is formed by dispersing insulative nanoparticles in a non-toxic reagent at a controlled pH using volatile bases with the aid of high-speed mechanical stirring in conjunction with ultrasonic mechanical stirring. Steps may be taken to promote the dispersion of the nanomaterials in the reagent, the steps including one or more of pH control, viscosity and mechanical agitation at medium and high speed, and the use of a surfactant or ultrasonic waves.

When cured, the insulating compound may have a low thermal conductivity. For example, the insulating compound may have a thermal conductivity within a range of 0.017 to 0.035 W/mK when exposed to a temperature of 1200° C. The cured insulating compound may also have a high reflectance and emissivity such that when radiated heat interacts with a surface of a layer of insulating compound, at least some of the heat is re-emitted, which reduces the surface temperature of the layer. For instance, the cured insulating compound can have an emissivity within a range of 0.90 to 1.0. In one example, the insulating compound may have an emissivity a range of 0.95 to 1.0. In another example, the insulating compound may have an emissivity of 1.0.

The insulating compound may have a low density. For example, in at least some aspects, the density of the cured insulating compound may be between 0.35 and 0.50 g·cm⁻³. The low weight of the insulating compound after curing may increase thermal insulation efficiency and minimize the weight added to the structure on which the insulating compound is applied. An additional feature in certain aspects involving an insulating compound may be a negligible density of volatile organic compounds (VOC).

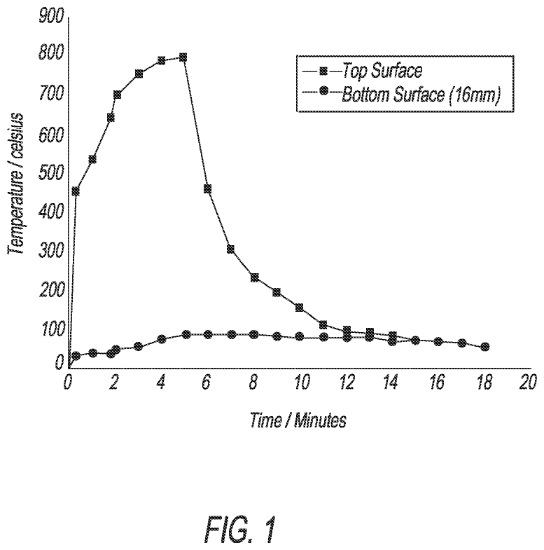

Aspects combining high reflectance and emissivity with low density and low thermal conductivity may provide a very high cooling rate. For instance, FIG. 1 is a graph showing the heating and cooling of a 16 mm thick sample, coated with the insulating compound, over time when subjected to a direct flame of 1200° C. The inventors found that the sample showed a surface temperature of 793° C. on the insulating compound coating and an opposite cold face side temperature of 79° C. after being exposed to a direct flame of 1200° C. After removing the sample from the heat, the surface temperature of the insulating compound coating fell to 57° C. in about 12 minutes.

The insulating compound may be thermally insulating over a broad range of high temperatures. For instance, the insulating compound can operate (e.g., demonstrates a thermal insulation effect) within a temperature range of 200 to 2100° C. Thermal conductivity of the insulating compound may increase as temperature increases. The insulating compound can operate within a temperature range of 500 to 2100° C., 750 to 2100° C., 1000 to 2100° C., 1200 to 2100° C., 1400 to 2100° C., 1700 to 2100° C., or another suitable range within 200 to 2100° C. The insulating compound may also be thermally insulating over a broad range of low temperature ranges. For instance, the insulating compound can operate within a temperature range of −200° C. to ambient temperature.

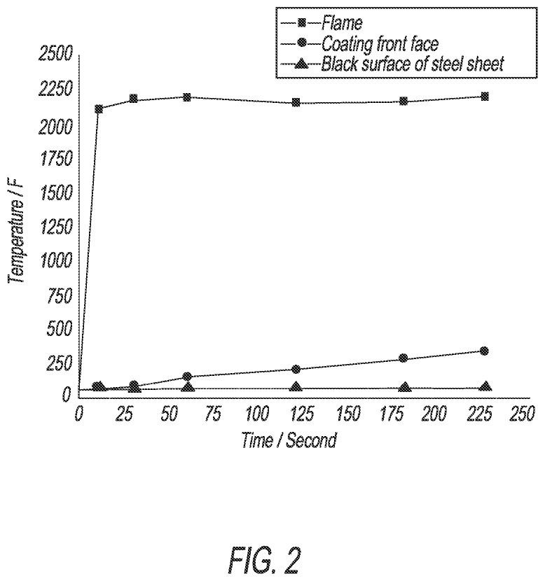

In a first example, an insulating compound prior to being cured includes, by mass: 2 to 60% insulative nanoparticles, 5 to 40% silica, 15 to 50% amorphous silica, 1 to 5% bentonite, and 5 to 50% water. In some instances of this first example, the insulating compound may further include, by mass: 1 to 10% inert pigments, 2 to 30% inorganic semiconductors, and 5 to 35% carbides. FIG. 2 is a graph showing the heating of the first example of the insulating compound incorporated into a polymer and coated on a steel sheet when the sample is exposed to direct flame. As shown in the graph, the fire exposure lasted about 3 minutes 45 seconds before it was terminated. The temperature on the front surface of the insulating compound coating layer gradually increased from 73.5° F. (23° C.) to about 342° F. (172° C.) while the flame temperature jumped to over 2000° F. (1100° C.) in about 11 seconds and maintained at that level for the duration of the test. The temperature on the back face of the steel sheet remained at between 72 to 73° F. (22° C. to 23° C.). The coating thickness estimated at the center of the fire exposure was in the range of 2 to 5 mm.

In this first example, the insulating compound when cured includes, by mass: 2 to 65% insulative nanoparticles, 5 to 60% silica, 15 to 50% amorphous silica and 1 to 7% bentonite. In some instances of this first example, the insulating compound when cured may further include, by mass: 2 to 20% inert pigments, 2 to 55% inorganic semiconductors, and 5 to 40% carbides.

In a second example, a cured insulating compound includes, by mass: 10 to 60% insulative nanoparticles, 5% to 40% silica, 15% to 50% amorphous silica, 1 to 10% inert pigments, 3 to 20% additives, 2 to 20% inorganic semiconductors, 5 to 50% electro-fused silica, and 5 to 30% fibers.

In a third example, an insulating compound prior to being cured includes, by mass: 5 to 50% insulative nanoparticles, 5% to 40% silica, 15% to 50% amorphous silica, 1 to 10% inert pigments, 2 to 15% inorganic semiconductors, 5 to 35% electro-fused silica, 5 to 30% fibers, and 30 to 50% water.

In this third example, the insulating compound when cured includes, by mass: 3 to 60% insulative nanoparticles, 3% to 50% silica, 15% to 55% amorphous silica, 1 to 15% inert pigments, 2 to 20% inorganic semiconductors, 3 to 95% electro-fused silica and 1 to 45% inorganic fibers.

In a fourth example, an insulating compound prior to being cured includes, by mass: 10 to 60% insulative nanoparticles, 5% to 40% silica, 15% to 50% amorphous silica, 1 to 10% inert pigments, 2 to 15% inorganic semiconductors, 5 to 35% electro-fused silica, 5 to 30% fibers, 2 to 4% bentonite, and 30 to 50% water.

In this fourth example, the insulating compound when cured includes, by mass: 10 to 70% insulative nanoparticles, 5% to 45% silica, 15% to 60% amorphous silica, 1 to 15% inert pigments, 2 to 20% inorganic semiconductors, 5 to 45% electro-fused silica, 5 to 35% inorganic fibers and 2 to 7% bentonite.

In a fifth example, an insulating compound prior to being cured includes, by mass: 15 to 70% insulative nanoparticles, 5% to 40% silica, 1 to 8% inert pigments, 2 to 20% inorganic semiconductors, 5 to 30% electro-fused silica, 5 to 27% fibers, 5 to 20% amorphous silica, 1 to 5% bentonite, and 30 to 50% water.

In this fifth example, the insulating compound when cured includes, by mass: 10 to 80% insulative nanoparticles, 5% to 45% silica, 1 to 13% inert pigments, 2 to 25% inorganic semiconductors, 5 to 55% electro-fused silica, 5 to 45% inorganic fibers, 5 to 25% amorphous silica and 1 to 7% bentonite.

In a sixth example, an insulating compound prior to being cured includes, by mass: 20 to 40% insulative nanoparticles, 5% to 40% silica, 2 to 23% inorganic semiconductors, 5 to 31% electro-fused silica, 5 to 21% fibers, 5 to 23% amorphous silica, 1 to 4% bentonite, and 20 to 60% water.

In this sixth example, the insulating compound when cured includes, by mass: 20 to 52% insulative nanoparticles, 5% to 52% silica, 2 to 30% inorganic semiconductors, 5 to 40% electro-fused silica, 5 to 40% inorganic fibers, 5 to 303% amorphous silica and 1 to 5% bentonite.

In a seventh example, an insulating compound prior to being cured includes, by mass: 30 to 80% insulative nanoparticles, 2 to 23% inorganic semiconductors, 5 to 33% silica spheres, 5 to 21% fibers, 5 to 23% amorphous silica, 1 to 4% bentonite, 5 to 15% carbides, and 20 to 60% water.

In this seventh example, the insulating compound when cured includes, by mass: 15 to 95% insulative nanoparticles, 2 to 30% inorganic semiconductors, 5 to 42% silica spheres, 5 to 29% inorganic fibers, 5 to 30% amorphous silica, 1 to 6% bentonite and 5 to 21% carbides.

In an eighth example, an insulating compound prior to being cured includes, by mass: 10 to 50% insulative nanoparticles, 2 to 23% inorganic semiconductors, 5 to 33% silica spheres, 5 to 21% fibers, 5 to 23% amorphous silica, 1 to 4% bentonite, 5 to 30% electro-fused silica, 5 to 15% carbides, and 20 to 60% water.

In this eighth example, the insulating compound when cured includes, by mass: 10 to 65% insulative nanoparticles, 2 to 33% inorganic semiconductors, 5 to 43% silica spheres, 5 to 29% inorganic fibers, 5 to 33% amorphous silica, 1 to 6% bentonite, 5 to 45% electro-fused silica and 5 to 25% carbides.

In a ninth example, a cured insulating compound includes, by mass: 10 to 60% insulative nanoparticles, 5% to 40% silica, 15% to 50% amorphous silica, 1 to 10% inert pigments, 3 to 20% additives, and 2 to 20% inorganic semiconductors.

In a tenth example, an insulating compound prior to being cured includes, by mass: 15 to 40% hydrated silicate, 40 to 80% insulative particles (e.g., nanoparticles), and 5 to 17% water. In some aspects, the tenth example of the insulating compound may further include fibers (e.g., 5 to 20% by mass). In some aspects, the hydrated silicate is thermally treated with aluminum and magnesium to form a fibrous aluminum silicate. In various aspects of the tenth example, the insulating compound prior to being cured includes 15 to 40% magnesium silicate aluminum, 5 to 20% fibers, 40 to 60% insulative particles (e.g., nanoparticles), and 5 to 15% water. The tenth example of the insulating compound can be particularly useful for fireproofing and lowering the thermal conductivity of a material. The tenth example can also be used in various suitable carriers other than silica spheres, which can be beneficial because silica spheres can have less than desired mechanical properties in certain applications. Stated differently, applying a material including the insulating compound in this tenth example to an object (e.g., a pipe) does not reduce the object's mechanical properties, in contrast to at least some typical insulation materials that use silica spheres. Example suitable carriers include water-based resins, solvent-based resins, thermoplastics, thermosets, epoxy, orthophthalic, cementitious materials, and silicones.

In this tenth example, the insulating compound when cured includes, by mass: 15 to 45% magnesium silicate aluminum, 5 to 23% inorganic fibers and 40 to 67% insulative particles.

While the insulating compound has a variety of applications, in the present disclosure, the insulating compound may be cured and used as an additive in the composition of matter described below. For example, the cured insulating compound may be crushed and mixed with the other components of the composition of matter, which increases the resistance to thermal and electrical flow of the composition of matter. It will be appreciated that the insulating compound can lower the thermal conductivity of a variety of materials and not only the provided composition of matter. For example, in some aspects, the insulating compound may be sprayed onto a material to form a uniform finishing layer of protective coating on the material.

### Composition of Matter

In an example, a composition of matter, prior to being cured, includes cellulose (e.g., 5 to 50%, 10 to 50%, 5 to 32%, 10 to 32%, 5 to 25%, or 10 to 25%), the insulating compound (e.g., 0.5 to 5%, 1 to 5%, 0.5 to 4%, or 1 to 4%), insulative particles (e.g., 3 to 24%, 10 to 24%, 3 to 20%, or 10 to 20%), and water (e.g., 30 to 90%, 40 to 90%, 30 to 60%, or 40 to 60%). In this example, the cured composition of matter with the water evaporated includes cellulose (e.g., 10 to 70%, 15 to 70%, 20 to 70%, 10 to 50%, 15 to 50%, or 20 to 50%), the insulating compound (e.g., 1 to 30%, 1 to 25%, 1 to 15%, 1 to 10%, 3 to 30%, 3 to 25%, 3 to 15%, 3 to 10%, 5 to 30%, 5 to 25%, 5 to 15%, or 5 to 10%), and insulative particles (e.g., 5 to 30%, 5 to 25%, 10 to 30%, or 10 to 25%). The insulating compound included in the composition of matter may be any of the first, second, third, fourth, fifth, sixth, seventh, eighth, ninth, or tenth example insulating compound provided above, or another suitable composition consistent with the above description of the insulating compound.

Cellulose is a natural polymer extracted from plant and vegetable fibers with a general chemical formula of C₆H₁₀O₅ and serves as a lightweight structural component of the No, their chemical structure is the same, as the recycled one comes from the naturalcomposition of matter. In at least some aspects, the composition of matter includes cellulose fibers. The cellulose fibers may include 60 to 80% cellulose, 5 to 20% lignin, and 20% trapped moisture. The cellulose fibers may further include traces of hemicellulose or other residual chemical components in some instances. In some aspects, the cellulose fibers may include recycled cellulose. In such aspects, the recycled cellulose may include 75 to 85% recycled paper fiber by mass. The remaining 15 to 25% may include various filler materials. Recycled cellulose fibers retain desirable structural properties for use with the composition of matter.

In at least some aspects, the insulative particles may be nanoparticles. For example, an insulative nanoparticle may have a transverse dimension (e.g., diameter) within a range of 1 to 100 nanometers (nm), inclusive. In some aspects, at least half of the particles of the insulative nanoparticles have a transverse dimension within the range of 1 to 100 nm, inclusive. In such aspects, the particles of the insulative nanoparticles that are outside the range have a transverse dimension within a range of greater than 100 nm and less than or equal to 1000 nm. In some aspects, all of the particles of the insulative nanoparticles have a transverse dimension within the range of 1 to 100 nm, inclusive.

The proportion of insulative particles indicated for the composition of matter may be the same type of particles as the proportion of insulative particles included in the insulating compound or may be a different type of particles.

In various aspects, the pre-cured composition of matter may further include a suitable combination of one or more of the following: a phosphate additive (e.g., 0.5 to 5% or 1 to 5%), a phosphate filler (e.g., 1 to 12% or 1 to 8%), a binder (e.g., greater than 0% and less than or equal to 10% or 5%), and silica (e.g., greater than 0% and less than or equal to 12% or 1 to 8%).

In various aspects, the cured composition of matter may further include a suitable combination of one or more of the following: a phosphate additive (e.g., 1 to 15% or 2 to 12%), a phosphate filler (e.g., 5 to 30% or 8 to 25%), a binder (e.g., 3 to 30% or 4 to 20%), and silica (e.g., 1 to 20% or 1 to 15%).

In some aspects, an phosphate additive is included in the composition of matter to improve the fire-resistance (e.g., anti-flame spread) characteristics of the composition of matter. For instance, the phosphate additive is an inorganic compound that has a chemical structure that, when subjected to an impinging flame or heat flux, results in the production of a gas that replaces oxygen near the surface of the cured composition of matter, which restrains a flame from expanding due to lack of oxygen. The chemical structure of the phosphate additive is a polyphosphate chain (e.g., a long phosphate molecule) that includes a quantity of monomers attached to the phosphate chain that results in the off gas that replaces oxygen. In some aspects, the phosphate additive may also serve as a thickening agent for the composition of matter. In various aspects, the phosphate additive is not water soluble.

In some aspects, a phosphate filler is included in the composition of matter to improve the intumescence properties of the composition of matter. For instance, the phosphate filler is an inorganic compound that has a chemical structure that, when subjected to an impinging flame or heat flux, results in aiding carbonizing (e.g., intumescence) of the organic material present in the composition of matter (e.g., cellulose, binder, etc.), which prevents further flame spread. The chemical structure of the phosphate filler is a polyphosphate chain (e.g., a long phosphate molecule) that includes a quantity of monomers attached to the phosphate chain that results in the phosphate filler acting with organic matter to serve as an intumescent agent. In at least some aspects, the quantity of monomers attached to the phosphate chain of the phosphate filler is different than the quantity of monomers attached to the phosphate chain of the phosphate additive. The phosphate filler may be water soluble.

In some aspects, a binder is included in the composition of matter that holds the components of the composition of matter together. The binder may also allow for a clean (e.g., even) edge when the cured composition of matter is cut or stamped. In some aspects, without the binder the fibers of the composition of matter around the cut (or stamped) edges may flake and create uneven edges. In at least some aspects, the binder may be water-based. For example, the binder may include 45% solids and 55% water. In some aspects, the binder may be a resin (e.g., polymeric resin). Example resins include acrylic, alchemical, epoxy, polyurethane resins, phenol-formaldehyde, polyurethane, furfural resin, poly acrylonitrile, polyimide, sucrose and tannin. For example, the binder may be an acrylic water-based emulsion resin.

In some aspects, silica is included in the composition of matter that helps reflect heat, which increases the range of temperatures the composition of matter can withstand while still displaying fire-resistance properties. In such aspects, the silica may be in the form of particles (e.g., spheres). In such aspects, at least some of the silica particles may have a transverse dimension (e.g., diameter) within a range of 1 to 100 micrometers (um), inclusive. For example, in some aspects, at least half of the particles of the silica have a transverse dimension within the range of 1 to 100 μm, inclusive. In such aspects, the particles of the silica that are outside the range have a transverse dimension within a range of greater than 100 μm and less than or equal to 1000 μm. In some aspects, all of the particles of the silica have a transverse dimension within the range of 1 to 100 μm, inclusive.

The composition of matter may be formed by dispersing the components of the pre-cured composition of matter in the pre-cured proportions provided in the preceding examples in a water-based reagent (e.g., water or a combination of water and resin) to form a slurry with the aid of mechanical stirring (e.g., high-speed, ultrasonic, etc.). Steps may be taken to promote the dispersion of the components in the reagent, such as monitoring viscosity and saturation of the slurry. The mixing results in the formation of a paste. In some aspects, the resulting paste can be pressed and shaped into various geometries, sizes, and thicknesses depending on the application. When in the desired shape, the paste can be cured, which evaporates the water from the paste and solidifies the cured composition of matter in the desired shape. In some aspects, the paste can be cured without being shaped. For example, the resulting paste can be sprayed onto an a surface and then cured when on the surface.

Example applications of the composition of matter will now be discussed. A method of use of the composition of matter generally includes positioning the composition of matter relative to a structure thereby providing fire-resistance to the structure. In some aspects, positioning the composition of matter relative to the structure may involve attaching (e.g., with adhesive) the composition of matter to the structure or may involve integrally forming the composition of matter with the structure.

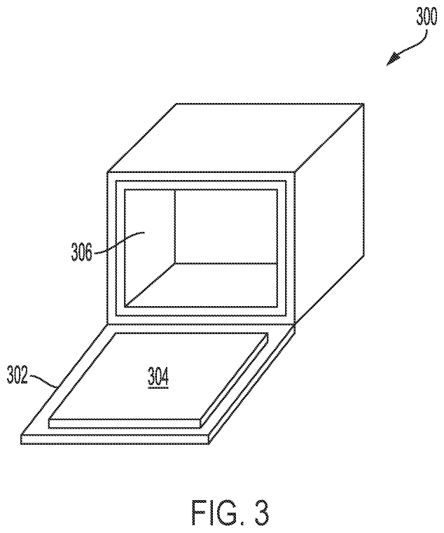

In an example, FIG. 3 depicts an application of the composition of matter as inserts 304, 306 in a box 300 (e.g., a cardboard box) to ship flammable contents. Each of the inserts 304, 306 may be a pad (e.g., denim or polyethylene terephthalate) that has been sprayed with the composition of matter. The composition of matter penetrates into the textiles of the pad such that the pad serves as a structural component for the composition of matter. In various embodiments, the inserts 304, 306 may each have a thickness within a range of ¼ inch to ¼ inch. A first insert 304 may be positioned adjacent a side 302 of the box 300 that opens to allow access to an interior of the box 300. A second insert 306 may line the remaining interior of the box 300. In some aspects, the second insert 306 may be a single piece that was shaped to fit the interior of the box 300. In other aspects, the second insert 306 may include five inserts that are each similar to the first insert 304 and are each adjacent a respective interior side of the box 300. In the method of use, positioning the composition of matter relative to the box 300 in this example may include positioning the first insert 304 adjacent to the side 302 or positioning the second insert 306 adjacent to the remaining interior of the box 300. In this way, should the flammable contents within the box 300 ignite, the composition of matter will contain the flames within the box 300 for a much longer period of time than the box 300 would otherwise contain the flames. For example, a cardboard box 300 would catch on fire almost immediately and spread the flames to other boxes and items positioned near the box 300. In some aspects, each of the first insert 304 and the second insert 306 may be adhered to the interior of the box 300.

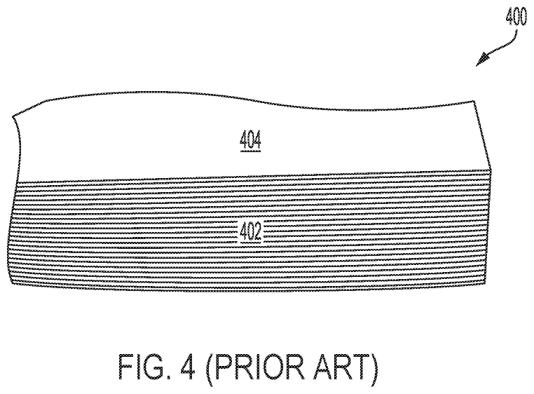

Another example application includes the composition of matter being used as a fire-resistant panel. For example, FIG. 4 depicts a conventional insulation board 400 that includes insulation material 402 and a backer board 404 coupled to a surface of the insulation material 402. The insulation material 402 may be a denim insulation pad or another suitable insulation material. Rather than using the conventional insulation board 400, the composition of matter can be formed into a panel that is used in a similar way as the conventional insulation board 400 and replaces the conventional insulation board 400. In various embodiments, the panel may have a thickness within a range of ¼ inch to ½ inch. In some embodiments, rather than the composition of matter being formed into a panel, the composition of matter may be sprayed onto a pad as described above with respect to the inserts 304, 306. In the method of use, the panel may be positioned relative to a structure such as a housing wall to provide fire resistance to the structure. Another example use of the panel includes using the panel as backer material for construction materials that require a fire rating.

When the composition of matter is cured without shaping the paste, in some aspects, the cured composition of matter can be reduced (e.g., crushed) into loose fill material of varying granularities that may be mixed with other materials, such as for insulation purposes that require fire resistance. For example, the reduced composition of matter may be isolated or dispersed in polymeric matrices (e.g., a resin), composites, metal alloys, inorganic materials (e.g., plaster, concrete, mortar, etc.), or other suitable materials to increase the fire resistance of those materials. The composition of matter can additionally lower the thermal conductivity of a variety of materials. In other aspects still, the composition of matter may be sprayable (e.g., manually, airless, with a spray system or projection equipment, or the like). For example, the composition of matter may be sprayed onto an object to form a uniform finishing layer of protective coating on the object.

In a first example, the cured composition of matter includes, by mass: 10 to 70% cellulose, 1 to 15% insulating compound, and 5 to 30% insulative particles.

In a second example, the cured composition of matter includes, by mass: 10 to 70% cellulose, 1 to 15% insulating compound, 5 to 30% insulative particles, and 1 to 15% phosphate additive or 5 to 30% phosphate filler.

In a third example, the cured composition of matter includes, by mass: 10 to 70% cellulose, 1 to 15% insulating compound, 5 to 30% insulative particles, 1 to 15% phosphate additive or 5 to 30% phosphate filler, and 3 to 30% binder or 1 to 20% silica.

In a fourth example, the cured composition of matter includes, by mass: 15 to 50% cellulose, 1 to 10% insulating compound, and 10 to 25% insulative particles.

In a fifth example, the cured composition of matter includes, by mass: 15 to 50% cellulose, 1 to 10% insulating compound, 10 to 25% insulative particles, and 2 to 12% phosphate additive or 8 to 25% phosphate filler.

In a sixth example, the cured composition of matter includes, by mass: 15 to 50% cellulose, 1 to 10% insulating compound, 10 to 25% insulative particles, 2 to 12% phosphate additive or 8 to 25% phosphate filler, and 4 to 20% binder or 1 to 15% silica.

In a seventh example, the pre-cured composition of matter includes, by mass: 5 to 50% cellulose, 0.5 to 5% insulating compound, 3 to 24% insulative particles, and 30 to 90% water.

In an eighth example, the pre-cured composition of matter includes, by mass: 5 to 50% cellulose, 0.5 to 5% insulating compound, 3 to 24% insulative particles, 30 to 90% water, and 0.5 to 5% phosphate additive or 1 to 12% phosphate filler.

In a ninth example, the pre-cured composition of matter includes, by mass: 5 to 50% cellulose, 0.5 to 5% insulating compound, 3 to 24% insulative particles, 30 to 90% water, 0.5 to 5% phosphate additive or 1 to 12% phosphate filler, and greater than 0% and less than or equal to 10% binder or greater than 0% and less than or equal to 12% silica.

In a tenth example, the pre-cured composition of matter includes, by mass: 10 to 32% cellulose, 1 to 4% insulating compound, 10 to 24% insulative particles, and 30 to 60% water.

In an eleventh example, the pre-cured composition of matter includes 10 to 32% cellulose, 1 to 4% insulating compound, 10 to 24% insulative particles, 30 to 60% water, and 1 to 5% phosphate additive or 1 to 8% phosphate filler.

In a twelfth example, the pre-cured composition of matter includes, by mass: 10 to 32% cellulose, 1 to 4% insulating compound, 10 to 24% insulative particles, 30 to 60% water, 1 to 5% phosphate additive or 1 to 8% phosphate filler, and greater than 0% and less than or equal to 5% binder or 1 to 8% silica.

The inventors have found that the cured composition of matter exhibits a variety of desirable properties. For example, the cured composition of matter exhibits high heat insulation combined with a low smoke density (e.g., a smoke developed index of 0) and no flame spread (e.g., a flame spread index of 0). For example, the thermal conductivity constant (at 25° C.) of the cured composition of matter is within a range of 0.040 to 0.45 kW/mK, and in some embodiments, within a range of 0.040 to 0.15 kW/mK. In another example, the cured composition of matter resists heat transfer from a heat flux source or impingent flame. In another example, the cured composition of matter is lightweight compared to typical fire-resistant materials. For instance, the cured composition of matter may have a density within a range of 0.4 to 0.8 grams per cubic centimeter (g/cm³). In another example, the cured composition of matter may have an emissivity greater than 0.89.

In one or more aspects, the present composition of matter may include additional aspects, such as any single aspect or any combination of aspects described below or in connection with one or more other processes or devices described elsewhere herein. In a first aspect, a composition of matter includes, by mass: 10 to 70% cellulose; 1 to 15% insulating compound; and 5 to 30% insulative particles. The composition of matter is fire-resistant, and the insulating compound includes, by mass: 2 to 60% insulative particles, 5 to 40% silica, and 15 to 50% amorphous silica.

In a second aspect, in combination with the first aspect, the composition of matter further includes, by mass, 1 to 15% phosphate additive.

In a third aspect, in combination with one or more of the first aspect or the second aspect, the composition of matter further includes, by mass, 5 to 30% phosphate filler.

In a fourth aspect, in combination with one or more of the first aspect through the third aspect, the composition of matter further includes, by mass, 3 to 30% water-based binder.

In a fifth aspect, in combination with one or more of the first aspect through the fourth aspect, the composition of matter further includes, by mass, 1 to 20% silica.

In a sixth aspect, in combination with one or more of the first aspect through the fifth aspect, the cellulose includes recycled cellulose.

In a seventh aspect, in combination with one or more of the first aspect through the sixth aspect, the insulative particles are nanoparticles.

In an eighth aspect, in combination with one or more of the first aspect through the seventh aspect, the composition of matter at 25° C. has a thermal conductivity constant within a range of 0.040 to 0.45 kW/mK.

In a ninth aspect, in combination with one or more of the first aspect through the eighth aspect, the insulating compound further includes, by mass, 5 to 50% electro-fused silica.

In a tenth aspect, in combination with one or more of the first aspect through the ninth aspect, the insulating compound further includes, by mass, 20 to 40% hydrated silicate.

In an eleventh aspect, in combination with one or more of the first aspect through the tenth aspect, the insulating compound further includes, by mass, 1 to 5% bentonite.

In a twelfth aspect, in combination with one or more of the first aspect through the eleventh aspect, the insulating compound further includes, by mass, 5 to 50% semiconductors.

In a thirteenth aspect, in combination with one or more of the first aspect through the twelfth aspect, the insulating compound further includes, by mass, 1 to 10% inert pigments.

In a fourteenth aspect, in combination with one or more of the first aspect through the thirteenth aspect, the insulating compound further includes, by mass, 5 to 35% carbides.

In a fifteenth aspect, in combination with one or more of the first aspect through the fourteenth aspect, a method includes positioning a composition of matter relative to a structure thereby providing fire-resistance to the structure. The composition of matter may be the composition of matter of any of the first through the fourteenth aspects.

In a sixteenth aspect, in combination with the fifteenth aspect, positioning the composition of matter relative to the structure includes positioning a panel of the composition of matter adjacent a surface of the structure.

In a seventeenth aspect, in combination with the sixteenth aspect, the structure is a receptacle and the composition of matter is positioned relative to the receptacle so as to define an interior of the receptacle.

In an eighteenth aspect, in combination with one or more of the second aspect through the eighth aspect, a composition of matter includes, by mass: 10 to 70% cellulose; 1 to 15% insulating compound; and 5 to 30% insulative particles. The composition of matter is fire-resistant, and the insulating compound includes, by mass: 15 to 40% hydrated silicate, and 40 to 80% insulative particles.

In a nineteenth aspect, in combination with the eighteenth aspect, the insulating compound includes, by mass, 15 to 40% magnesium silicate aluminum as a product of the hydrated silicate being thermally treated with aluminum and magnesium.

In a twentieth aspect, in combination with one or more of the eighteenth aspect through the nineteenth aspect, the insulative particles are nanoparticles.

In a twenty-first aspect, in combination with one or more of the first aspect through the twentieth aspect, the composition of matter has a density within a range of 0.4 to 0.8 g/cm³.

The above specification and examples provide a complete description of the structure and use of illustrative aspects. Although certain aspects have been described above with a certain degree of particularity, or with reference to one or more individual aspects, those skilled in the art could make numerous alterations to the disclosed aspects without departing from the scope of this invention. As such, the various illustrative aspects of the products, systems, and methods are not intended to be limited to the particular forms disclosed. Rather, they include all modifications and alternatives falling within the scope of the claims, and aspects other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several aspects.

The claims are not intended to include, and should not be interpreted to include, means-plus-or step-plus-function limitations, unless such a limitation is explicitly recited in a given claim using the phrase(s) “means for” or “step for,” respectively.

The invention is claimed as follows:

1. A composition of matter comprising, by mass:
10 to 70% cellulose;
1 to 15% insulating compound; and
5 to 30% insulative particles,
wherein the insulating compound includes, by mass of the insulating compound:
2 to 60% insulative particles,
5 to 40% silica, and
15 to 50% amorphous silica.

2. The composition of matter of claim 1, further comprising, by mass, 1 to 15% phosphate additive.

3. The composition of matter of claim 1, further comprising, by mass, 5 to 30% phosphate filler.

4. The composition of matter of claim 1, further comprising, by mass, 3 to 30% water-based binder.

5. The composition of matter of claim 1, further comprising, by mass, 1 to 20% silica.

6. The composition of matter of claim 1, wherein the cellulose includes recycled cellulose.

7. The composition of matter of claim 1, wherein the insulative particles are nanoparticles.

8. The composition of matter of claim 1, wherein the composition has a thermal conductivity constant at 25° C. within a range of 0.040 to 0.45 kW/mK.

9. The composition of matter of claim 1, wherein the insulating compound further includes, by mass, 5 to 50% electro-fused silica.

10. The composition of matter of claim 1, wherein the insulating compound further includes, by mass, 20 to 40% hydrated silicate.

11. The composition of matter of claim 1, wherein the insulating compound further includes, by mass, 1 to 5% bentonite.

12. The composition of matter of claim 1, wherein the insulating compound further includes, by mass, 5 to 50% semiconductors.

13. The composition of matter of claim 1, wherein the insulating compound further includes, by mass, 5 to 35% carbides.

14. The composition of matter of claim 1, having a density within a range of 0.4 to 0.8 g/cm³.

15. A method comprising:
positioning a composition of matter relative to a structure thereby providing fire-resistance to the structure, wherein the composition of matter includes, by mass:
10 to 70% cellulose;
1 to 15% insulating compound; and
5 to 30% insulative particles,
wherein the insulating compound includes, by mass:
2 to 60% insulative particles,
5 to 40% silica, and
15 to 50% amorphous silica.

16. The method of claim 15, wherein positioning the composition of matter relative to the structure includes positioning a panel of the composition of matter adjacent a surface of the structure.

17. The method of claim 16, wherein the structure is a receptacle and the composition of matter is positioned relative to the receptacle so as to define an interior of the receptacle.

18. A composition of matter comprising, by mass:
10 to 70% cellulose;
1 to 15% insulating compound; and
5 to 30% insulative particles,
wherein the insulating compound includes, by mass: 15 to 40% hydrated silicate, and 40 to 80% insulative particles.

19. The composition of matter of claim 18, wherein the insulating compound includes, by mass, 15 to 40% magnesium silicate aluminum as a product of the hydrated silicate being thermally treated with aluminum and magnesium.

20. The composition of matter of claim 18, wherein the insulative particles are nanoparticles.
